(19) United States
(12) Patent Application Publication
(10) Pub. No.: US 2013/0083813 A1
(43) Pub. Date: Apr. 4, 2013

(54) NARROW LINEWIDTH BRILLOUIN LASER

(71) Applicant: SCHLUMBERGER TECHNOLOGY CORPORATIO, Sugar Land, TX (US)

(72) Inventor: Arthur H. Hartog, Winchester (GB)

(73) Assignee: SCHLUMBERGER TECHNOLOGY CORPORATION, Sugar Land, TX (US)

(21) Appl. No.: 13/686,567

(22) Filed: Nov. 27, 2012

Related U.S. Application Data
(62) Division of application No. 12/633,162, filed on Dec. 8, 2009.

(51) Int. Cl. H01S 3/30

(52) U.S. Cl. CPC H01S 3/302
USPC 372/6

(57) ABSTRACT

A Brillouin laser having a narrowed linewidth, reduced relative intensity noise, and increased output power includes a pump laser that provides pump energy to an optical fiber resonant cavity to stimulate Brillouin emission. The output of pump laser is stabilized and its linewidth is narrowed by locking the frequency and phase of the optical signal generated by the pump laser to a longitudinal mode of the optical fiber resonant cavity. In addition, the resonant cavity is temperature and/or strain-tuned so that the Brillouin gain is substantially centered on a longitudinal mode of the cavity, thereby ensuring that the Brillouin frequency shift is substantially equal to an integer number of the free spectral range of the cavity.

### BACKGROUND

Optical fiber sensors, especially interferometric sensors and more especially interferometric sensors where there is a large optical path imbalance (i.e., an interferometric large path imbalance fiber-optic sensor (ILPIFOS)), generally are interrogated using optical sources with a narrow optical bandwidth. Whereas an ideal optical source may be viewed as a source emitting a single optical frequency, in practice, optical sources emit over a range of frequencies. This frequency range may be defined in terms of a spectral width, which, when analyzed in the frequency domain, corresponds to the width of the peak occupying the energy generated by the source. The measurement of this spectral width is generally referred to as the optical source's linewidth. As examples, a light-emitting diode generally emits its power over a spectral width of tens of nanometers (i.e., several THz), while a semiconductor distributed feedback laser typically emits its power over a spectral width of 0.5-1.0 MHz. By comparison, certain solid state lasers have achieved linewidths below 1.0 kHz and some recent fiber lasers may emit their power over a spectrum having a width of a few hundred hertz. The performance of an optical source may also be described in terms of phase (or frequency) noise or coherence time (i.e., the time over which the phase of the optical output may be predicted from past emission). An analysis of the noise properties of an ILPIFOS requires an understanding of the spectral properties of the frequency fluctuation of the optical source. The spectral density of the variation of the source frequency generally is plotted as a function of frequency. Typically, this quantity increases with decreasing frequency. A modern fiber distributed feedback laser may exhibit a frequency noise of order 100 Hz/Hz^{1/2} at 100 Hz.

For interferometric fiber-optic sensors where the optical paths differ by a large value (say more than 0.1 meter), the frequency noise of the interrogating source is critical to the noise floor of the system. For example, for a path imbalance of 10 meters, even a frequency noise of 100 Hz/Hz^{1/2} may result in a sensor noise of a few mrad/Hz^{1/2}, which could limit system performance. In some cases, the amplitude fluctuations of the interrogating source (i.e., the “relative intensity noise” or RIN) also influence system performance.

### BRIEF DESCRIPTION OF THE DRAWING

Certain embodiments of the invention will hereafter be described with reference to the accompanying drawings, wherein like reference numerals denote like elements. It should be understood, however, that the accompanying drawings illustrate only the various implementations described herein and are not meant to limit the scope of various technologies described herein. The drawings are as follows:

FIG. 1 is a schematic representation of an exemplary narrow linewidth Brillouin laser in accordance with an embodiment of the invention;

FIG. 2 is a schematic representation of another exemplary narrow linewidth Brillouin laser in accordance with an embodiment of the invention;

FIG. 3 is a schematic representation of an exemplary narrow linewidth Brillouin laser in accordance with yet another embodiment of the invention;

FIG. 4 is a schematic representation of an exemplary narrow linewidth Brillouin laser in accordance with a further embodiment of the invention; and

FIG. 5 is a schematic representation of an exemplary narrow linewidth Brillouin laser in which a blazed fiber Bragg grating is formed in the optical fiber resonator cavity, in accordance with an embodiment of the invention.

### DETAILED DESCRIPTION

Exemplary embodiments of the invention provide an optical source having a narrowed linewidth, a reduced relative intensity noise (RIN), and/or improved output power that may be used to interrogate optical fiber sensors and, particularly, interferometric optical sensors having a large optical path imbalance. In embodiments of the invention, the narrowed bandwidth optical source is a Brillouin laser.

While a Brillouin laser has been known for many years, its performance has been limited by a number of effects. For instance, a Brillouin laser is longitudinally multimode (i.e., multiple modes of the Brillouin laser exist under the Brillouin gain curves), and, thus, is not a fundamentally stable narrowband source. Generally, the free-spectral range (FSR) (i.e., the frequency separation between successive longitudinal modes of the resonator cavity) of the Brillouin laser often is significantly less than the width of the Brillouin gain spectrum. The lower the FSR is relative to the gain spectrum, the more likely the laser will tend to mode-hop (i.e., jump from one longitudinal mode to one of the near modes) in response, for instance, to acoustically driven fluctuations in the length of the resonator cavity.

As another example, the effectiveness of spectral width narrowing in Brillouin lasers may be limited by the onset of second-order Stokes emissions. In general, the spectral width of a Brillouin laser may be narrowed by narrowing the spectral width of the pump laser. The relationship between the narrowing of the Brillouin laser relative to the pump spectral width can be expressed by the following equations:

$$Δ {v}_{s} = \frac{Δ {v}_{p}}{{K}^{2}} \\ K = 1 + {γ}_{A} / {Γ}_{c} \qquad ( 1 )$$

where Δυₛ and Δυₚ are, respectively, the linewidths of the Brillouin laser and pump laser, and γ_{A} and Γ_{c} are the damping factors of the acoustic phonons and the resonator cavity damping rate. Thus, if the cavity linewidth is substantially narrower than the Brillouin linewidth, the pump linewidth is narrowed roughly in proportion to the square of the ratio of the Brillouin linewidth to the cavity linewidth. However, the output power of a Brillouin laser is limited by the onset of the emission of the second-order Brillouin Stokes line. When the second-order Stokes emission reaches threshold in the Brillouin laser cavity, power is transferred from the first-order Stokes to the second-order Stokes. This has the effect of reducing the finesse of the Brillouin cavity and, thus, the effectiveness of the linewidth reduction given by Equation (1) above. To increase the output power, the output coupling of the Brillouin cavity may be increased, but this again reduces the finesse of the cavity.

Embodiments of the invention are directed toward reducing these limitations (and others) of Brillouin lasers, thus producing a Brillouin optical source having a stable, narrowed emission spectrum, reduced RIN and increased output power.

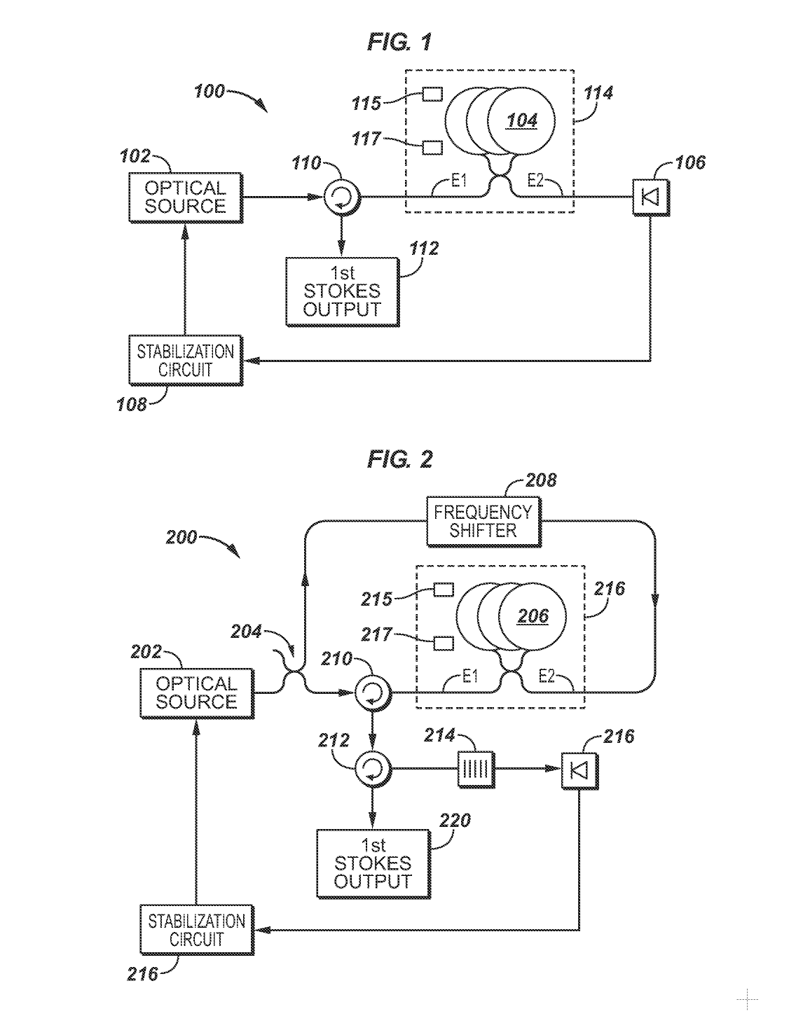

With reference now to FIG. 1, an exemplary embodiment of a Brillouin laser 100 is shown. The laser 100 includes an optical source (or pump laser) 102 (e.g., a semiconductor laser, fiber laser, etc.) that launches an optical signal into a fiber ring resonator cavity 104 in a first direction into a first end E1. In this embodiment, the frequency of the pump laser 102 is locked to a longitudinal mode of the cavity 104 by measuring the light emerging from the opposite end E2 of the cavity 104 with a receiver or optical detector 106. The output of the detector 106 is coupled to a stabilization circuit 108 that is based, for example, on the Pound-Drever-Hall (PDH) optical phase locking technique or other technique appropriate for stabilizing the laser 100 by locking the frequency of the pump laser 102 to a longitudinal mode of the cavity 104. In one embodiment of the invention, the stabilization technique involves modulating the frequency of the pump laser 102 and detecting the output signal emerging from the end E2 of the cavity 104 at the detector 106 at the modulation frequency. For instance, the frequency of the laser 102 may be adjusted by using an external modulator (e.g., an electro-optic or acousto-optic modulator). In embodiments which employ a semiconductor laser, the laser 102 may be frequency modulated by altering the injection current. As another example, the frequency output of other types of lasers may be adjusted by varying other parameters. For instance, the frequency of a fiber laser may be adjusted via a piezo-electric transducer that operates to vary the length of the resonant cavity. Regardless of the particular modulation technique used, the stabilization circuit 108 then mixes the detected signal with the original modulation signal and, based on the mixed signal, generates an appropriate feedback signal to correct the frequency of the pump laser 102. As a result, the pump laser 102 is locked to one of the longitudinal modes of the ring resonator cavity 104, while simultaneously narrowing the linewidth of the pump laser 102.

It should be understood that the PDH stabilization technique is only one exemplary technique for locking the frequency of the source 102 to a longitudinal mode of the optical fiber resonant cavity 104. Other stabilization techniques also are envisioned and within the scope of the invention.

Referring still to FIG. 1, at a sufficient level of optical power received from the frequency-stabilized pump optical source 102, the Brillouin laser 100 reaches threshold and Brillouin-shift emission emerges from the end E1, where it is separated by a circulator 110 to provide first-order Stokes output 112 having a narrowed linewidth.

In an exemplary embodiment, the optical fiber ring resonator cavity 104 comprises a polarization-maintaining fiber to ensure that a single polarization mode is active. Where two polarization modes are excited, each operates on its own independent resonances and a number of detrimental effects (such as beating between polarization modes) can occur. In other embodiments, the optical fiber that forms the cavity may be of a type that guides a single optical polarization.

Since the Brillouin shift (and associated gain curve) is completely uncorrelated to the mode structure of the resonator cavity, the modes of a Brillouin laser can lie anywhere within the gain curve. Brillouin gain generally is thought to be homogeneously broadened, which means that if energy is drained from one part of the gain curve due to lasing action, the entire gain curve is shifted down. Thus, homogeneous broadening tends to encourage a single mode to lase. Known Brillouin lasers generally have operated on this principle, with the FSR of the ring resonator selected to ensure that several longitudinal modes exist under the gain curve. Although this configuration makes for a simple construction and ensures some lasing, it is quite possible for two adjacent modes to exhibit similar gain. In such a case, the Brillouin laser may hop between modes.

In some embodiments of the invention, to prevent mode-hopping, the Brillouin frequency shift of the ring resonator 104 may be adjusted either by temperature-tuning the ring 104 (e.g., using appropriate heating elements), straining the ring 104 (e.g., on a piezo-electric transducer) or both temperature-tuning and straining the ring 104, such as by placing the fiber ring resonator 104 in a temperature and/or strain stabilized enclosure 114 that includes a heating element 115 and/or a strain element 117. The tuning is performed in a manner that substantially centers the Brillouin gain curve on one longitudinal mode of the resonator cavity 104, with the nearest modes having significantly lower gain than the central mode. For instance, to determine a suitable operating point, the temperature and/or strain applied to the resonator cavity 104 may be varied while monitoring the Brillouin output at conditions just above the threshold at which Brillouin lasing starts. Since the Brillouin output power increases as the Brillouin frequency shift matches one of the longitudinal modes of the cavity 104, the temperature and/or strain can be adjusted until a peak in the output power is observed. At this point, the Brillouin gain will be substantially centered on a longitudinal mode of the cavity 104. The temperature and/or strain applied to the cavity 104 that corresponds to this condition may then be maintained so that the resonant frequency of the cavity 104 is stabilized. As a result of this tuning, the Brillouin frequency shift is substantially equal to an integer number of FSRs of the cavity 104.

In an exemplary embodiment, the cavity 104 is selected so that its FSR is greater or equal to the Brillouin gain bandwidth, so as to ensure a significant discrimination between the central mode and its nearest neighbors, thus providing stable, longitudinal mode operation. As an example, at the operating wavelength of 1550 nm, the Brillouin linewidth is approximately 20 MHz (full-width at half-maximum (FWHM)). Thus, if an FSR of approximately 25 MHz (corresponding to an 8 meter ring resonator perimeter) is selected, the gain of the longitudinal modes adjacent to the central mode is down by a least a factor of two, which is more than sufficient to provide for single-mode operation. In fact, smaller FSRs than this may be selected provided that the cavity 104 is tuned such that the Brillouin gain curve is centered on the longitudinal mode structure.

The narrowing of the emission linewidth of a Brillouin laser in the embodiment shown in FIG. 1 arises from two separate, cumulative, effects. First, locking the frequency of the pump laser 102 to a longitudinal mode of the ring resonator 104 narrows the linewidth of the Brillouin output. In effect, the pump laser 102 is phase-stabilized to the phase of the recirculating light in the ring resonator 104, which is averaged over a time dependent on the finesse of the cavity 104. Second, the Brillouin emission further averages its phase over many passes around the resonator cavity 104, and this effect further narrows the emission by a factor proportional to the square of the ratio of the acoustic phonon lifetime to that of photons in the resonator 104.

However, when optical power is transferred from the pump laser 102 to Brillouin emission, this will, in effect, increase the cavity 104 losses at the pump wavelength, and thus lower the Q of the cavity 104. As a result, the linewidth of the pump laser 102 that has been narrowed by the stabilization technique is broadened when Brillouin emission is achieved. In an exemplary embodiment, this broadening may be avoided by using a separate, but related, frequency to lock the pump laser to the cavity, and use the original pump laser frequency only to pump the Brillouin laser (and not to control the linewidth of the optical source). An example of such an embodiment is illustrated in FIG. 2.

FIG. 2 shows an exemplary embodiment of a Brillouin laser 200 in which a fraction of the power of an optical source (or pump) 202 (e.g., a semiconductor laser, fiber laser, etc.) is tapped by a directional coupler 204 and fed to end E2 of an optical fiber ring resonator 206 through a frequency shifter (FS) 208. The frequency shifter 208 translates the frequency of pump laser 202 by a value that is selected to be an integer multiple of the free-spectral range of the ring resonator 206. The signal transmitted at this frequency-shifted frequency emerges at end E1 of the fiber ring resonator 206. In the embodiment shown, the signal emerging from end E1 is directed through circulators 210 and 212 and a narrowband filter 214 (e.g., a fiber Bragg grating) to an optical detector 216. In this embodiment, the filter 214 is configured to reflect the Brillouin output back through the circulator 212, but pass the frequency-shifted light emerging from end E1 of the resonator 206. As a result, the frequency-shifted light from the pump laser 202 entering at end E2 is used to stabilize the laser 200 and the unshifted light is used to pump the ring resonator cavity 206. In this embodiment, the benefits of a high finesse cavity 206 are retained while allowing a high power pump to be launched to drive the Brillouin laser.

The embodiment of the laser 200 shown in FIG. 2 also includes a stabilization circuit 216, which locks the pump 202 shifted frequency to a mode of the cavity 206 (e.g., by implementing the PDH technique). In some embodiments, the frequency modulation signal used in the stabilization technique may be imposed by the frequency shifter 208, rather than modulating the pump laser 202 itself. For instance, the frequency shifter 208 may comprise an acousto-optic modulator (AOM) operated in the first order, where, in addition to being modulated as a function of the amplitude of the RF signal entering the frequency shifter 208, the transmitted light is frequency shifted by the frequency of the RF drive signal. Acousto-optic modulators typically exhibit a video bandwidth of 10-15% of their RF central drive frequency. Thus, for a given nominal drive frequency, a suitable combination of the ring length operating frequency may be selected for reasonable AOM efficiency while operating at an integer multiple of the free spectral range of the resonator cavity 206. For example, if an AOM operating at the commonly used frequency of 110 MHz is selected, and a free-spectral range of greater than 25 MHz (to ensure single longitudinal mode operation) is desired, then an FSR of 27.5 MHz may be selected, resulting in a resonator length on the order of 7.5 meters. In this example, the frequency shifter 208 outputs a frequency-shifted optical signal that is separated from the pump 202 optical signal by four FSRs. Alternatively, for a slightly greater discrimination of the Brillouin side mode, an FSR of 36.6 MHz (which corresponds to a 5.6 meter ring perimeter) may be selected, which would result in the shifted optical signal differing by three FSRs from the pump optical signal.

In the embodiment shown in FIG. 2, the fiber ring resonator 206 is placed in a temperature and/or strain-stabilized enclosure 216 that may include a thermal element 215 and/or a strain element 217 to further stabilize the Brillouin laser (i.e., to center the Brillouin gain on a longitudinal mode of the cavity 206), as discussed above. The output 220 of the Brillouin laser 200 provided by the circulator 212 is at the first-order Stokes wavelength.

As previously discussed, a further limitation of the Brillouin laser is the fact that for high-finesse cavities, the threshold for Brillouin emission is reduced, which on the one hand eases the starting of the Brillouin lasing process but also reduces the maximum power that can be extracted before the second-order Stokes Brillouin emission appears. The second-order Stokes emission has two detrimental effects. First, it limits the output power available from the Brillouin laser. Second, because it acts as a loss mechanism in the Brillouin cavity, it reduces the finesse of the cavity, which significantly broadens the linewidth of the Brillouin output. In some embodiments of the invention, the second-order Stokes emission may be suppressed to limit the problems that result from the appearance of the second-order Stokes emission.

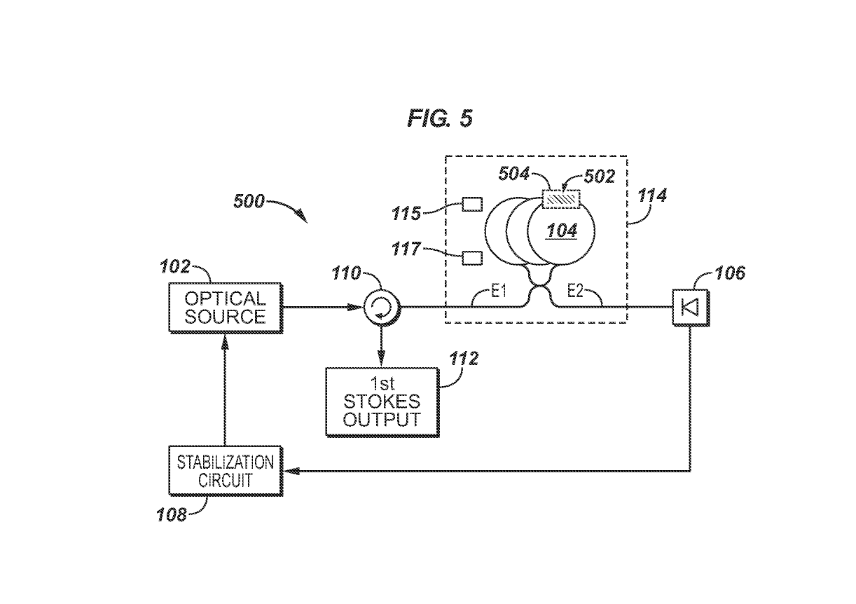

For instance, in exemplary embodiments, and as shown in laser 500 of FIG. 5, the accumulation of second-order Stokes Brillouin emissions may be suppressed by installing a means of inducing narrowband loss in the resonator cavity 104, such as a blazed fiber Bragg grating (FBG) 502. In accordance with this embodiment, the FBG 502 is configured to discriminate between the first-order Stokes emission (where low loss is desired) and the second-order Stokes emission (where high loss is desired). For instance, the FBG 502 may be configured to have its rejection peak on the order of 5 GHz, i.e., 40 pm. However, when the cavity 104 is temperature and/or strain-tuned to lock the pump laser to a longitudinal mode of the resonator cavity, the change in temperature and/or strain also will affect the FBG 502 and, thus, shift the FBG wavelength. To avoid this, when using a temperature-tuned and/or strain-tuned ring resonator (e.g., resonator 104), the temperature/strain control of the resonator cavity 104 may be implemented separately from that of the intra-cavity FBG 502 (or other intra-cavity device that induces narrowband loss). For instance, the FBG 502 may be placed in a separate temperature/strain-tuned enclosure 504 that is contained within the temperature/strain-induced enclosure 114.

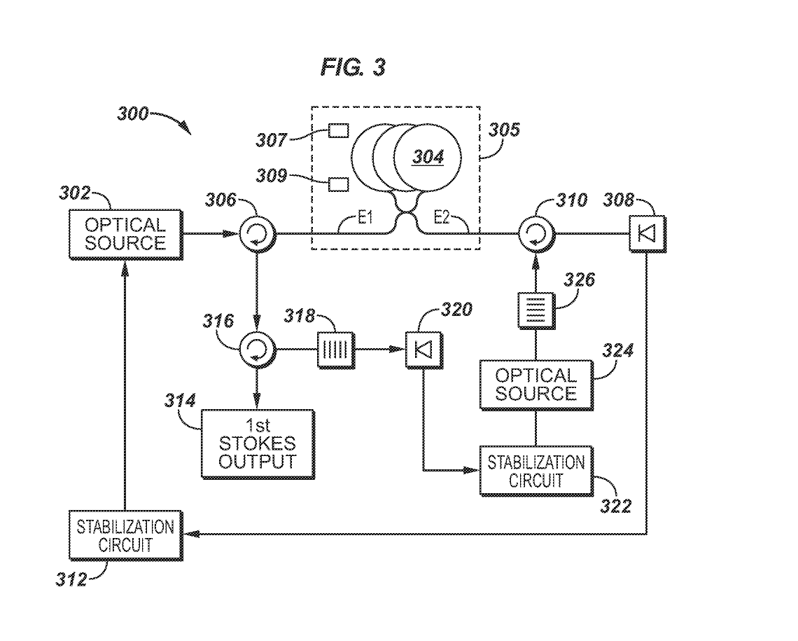

Alternatively, the second-order Stokes Brillouin emission may be suppressed by inducing narrowband loss by launching an optical signal into the resonator cavity in an appropriate direction at the third-order Stokes wavelength. An example of this embodiment is illustrated in FIG. 3. In the exemplary Brillouin laser 300 of FIG. 3, the laser 300 is configured so that a launched signal at the third-order Stokes wavelength interacts with an optical signal at the second-order Stokes wavelength and converts the second-order Stokes to a third-order Stokes emission. This conversion from the second to third-order Stokes prevents the buildup of power at the second-order Stokes, thus avoiding the transfer of power from first-order to second-order Stokes emissions. In effect, the presence of significant power in the third-order Stokes frequency induces any light that has accumulated in the second-order Stokes (e.g., through spontaneous scattering) to transfer to the third-order Stokes through the process of stimulated Brillouin scattering. This phenomenon induces a loss at the second-order Stokes wavelength, but not at other wavelengths (such as the first-order Stokes wavelength or the pump wavelength). As a result, the detrimental effects of the transfer of power from first to second-order Stokes are reduced and higher power operation for a given cavity finesse may be achieved.

As shown in FIG. 3, the Brillouin laser 300 includes a pump optical source 302 (e.g., a semiconductor laser, fiber laser, etc.) that launches an optical signal into a first end E1 of a fiber ring resonator 304 through a circulator 306. The resonator cavity 304 is contained within a temperature and/or strain stabilized enclosure 305 that may include a thermal element 307 and/or a strain element 309 for tuning the cavity 304. The optical signal emerging from the opposite end E2 of the resonator cavity 304 is detected by an optical detector 308, which is coupled to the resonator 304 through a circulator 310. The output of the detector 308 is coupled to a pump laser stabilization circuit 312 which is configured to lock the laser pump 302 to a longitudinal mode of the resonator 304, such as in the manner describe above (e.g., based on the PDH technique). The Brillouin emissions that are produced in response to the optical signal emerge from the end E1 of the resonant cavity. Light at the third-order Stokes Brillouin frequency is separated from the first-order Stokes Brillouin emissions so that the first-order Stokes are provided as an output and light at the third-order Stokes within the resonator 304 is used to suppress second-order Stokes emissions.

For instance, as shown in FIG. 3, the first-order Stokes output 314 of the Brillouin laser 300 is output through the circulators 306 and 316. A narrowband filter, such as a fiber Bragg grating 318, is coupled to the circulator 316 and is configured to reflect any emissions at the first-order Stokes wavelength back through the circulator 316 but pass any emissions at the third-order Stokes wavelength for detection by an optical detector 320. The output of the detector 320 is coupled to a stabilization circuit 322 that is configured to stabilize a laser 324 so that the laser 324 outputs a narrowed linewidth optical signal at the third-order Stokes wavelength. The third-order Stokes optical signal output from the laser 324 is injected into the end E2 of the ring resonator 304 through a narrowband filter 326 (e.g., a fiber Bragg grating), which is configured to pass light at the third-order Stokes wavelength, and the circulator 310.

While the embodiment of FIG. 3 illustrates the light launched at the third-order Stokes wavelength from an independent laser 324, in other embodiments, the third-order Stokes signal may be derived by taking a portion of the output of the pump laser 302 at the first-order Stokes frequency, frequency-shifting it by two Stokes shifts, and re-injecting it in the ring 304 in place of the third-order Stokes laser 324. The frequency-shifting may be implemented with an electro-optic modulator (e.g., either a phase or amplitude modulator), for example, having a bandwidth of approximately 20 GHz. In addition, in other embodiments, the first- and third-order Stokes Brillouin emissions may be separated in other manners as may be appropriate for the particular implementation of the laser 300. Yet further, while specific techniques for suppressing the second-order Stokes Brillouin emissions have been described, it should be understood that other suppression techniques are contemplated and within the scope of the invention.

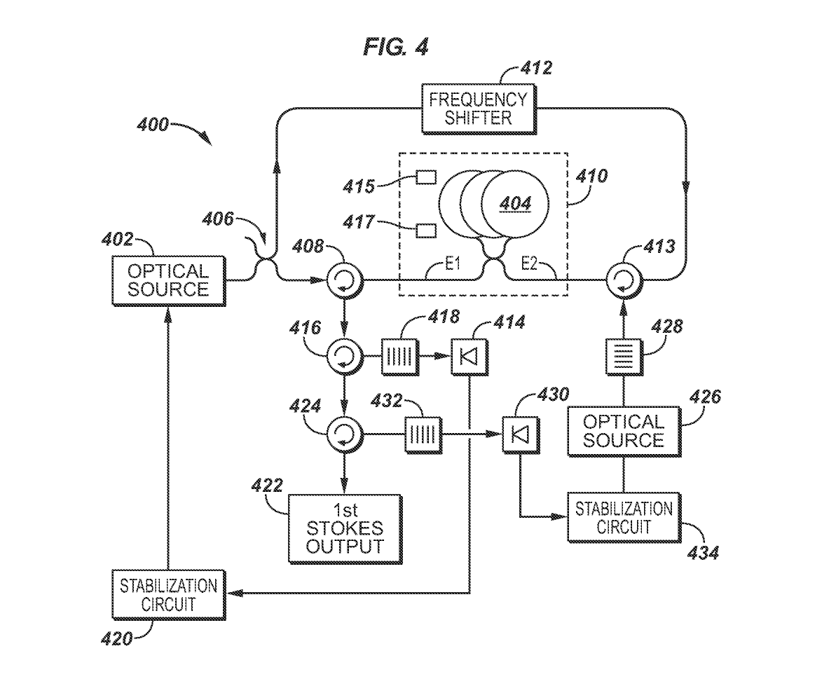

FIG. 4 illustrates yet another exemplary embodiment of a Brillouin laser 400 that combines the features of the lasers 200 and 300 shown in FIGS. 2 and 3, respectively. Here, the laser 400 includes an optical source 402 (e.g., a pump laser) that launches an optical signal into a first end E1 of a fiber ring resonator 404 through a directional coupler 406 and a circulator 408. The fiber ring resonator 404 is contained in a temperature and/or strain stabilized enclosure 410 that may include a thermal element 415 and/or a strain element 417 to adjust the temperature and/or strain imparted on the optical fiber that forms the cavity 404 such that the Brillouin gain curve is substantially centered on a longitudinal mode of the resonator cavity 404. A frequency shifter 412 translates the frequency of the pump laser 402 by an integer multiple of the FSR of the resonator 404 and injects it into the resonator 404 at an end E2 through a circulator 413. The frequency-shifted signal emerges at end E1 of the resonator 404 and is directed to an optical detector 414 through circulators 408 and 416 and narrowband filter or fiber Bragg grating 418 which is configured to pass the frequency-shifted signal. The output of the detector 414 is coupled to a pump laser stabilization circuit 420. As a result, the frequency-shifted signal from the pump laser 402 is used to lock the laser 402 to a mode of the resonator 404, while the unshifted signal from the laser 402 is used to pump the resonator 404 to achieve Brillouin emission. The output 422 of the laser 400 is a narrowed linewidth optical signal at the first-order Stokes wavelength and is provided through the circulators 408, 416 and 424.

In FIG. 4, second-order Stokes emissions are suppressed by launching an optical signal at the third-order Stokes wavelength into the end E2 of the resonator 404. Here, the third-order Stokes signal is output by a laser source 426 through a narrowband filter 428 (e.g., a fiber Bragg grating) which is configured to pass optical signals at the third-order Stokes wavelength. The third-order Stokes emission that emerges from the end El of the resonator 404 is directed to a detector 430 through circulators 408, 416 and 424 and a narrowband filter 432 (e.g., a fiber Bragg grating) that reflects signals at the first-order Stokes wavelength and passes signals at the third-order Stokes wavelength. The output of the detector 430 is provided to a stabilization circuit 434 that stabilizes the laser 426 at the third-order Stokes frequency. In an alternative embodiment of the laser 400, the third-order Stokes signal instead may be derived by frequency shifting the signal from the pump laser 402 by two Stokes wavelengths and injecting that frequency-shifted signal into the end E2 of the resonator 404.

Embodiments of the Brillouin lasers 100, 200, 300 or 400 may be employed as an optical source in a variety of interferometric sensing applications. For example, the Brillouin lasers 100, 200, 300, 400 may be used as the optical source in the interrogation of interferometric arrays, particularly arrays using heterodyne detection. In the case of heterodyne detection, the spectral purity of the optical source is particularly important because, in general, the local oscillator is emitted from the optical source at a substantially later time than the light returning from the sensing elements. Thus, a highly coherent source, such as the Brillouin laser 100, 200, 300 or 400 described herein, is particularly useful.

Embodiments of the Brillouin lasers 100, 200, 300, 400 may also be used in coherent optical time domain reflectometry (C-OTDR), where a short pulse of coherent light is launched into a fiber optic cable. When C-OTDR is used in sensing applications, the C-OTDR system detects disturbances as a function of distance along the fiber optic cable, because such disturbances alter the phase relationship between scattering elements within the distance occupied by the optical probe pulse. C-OTDR has been shown to be valuable in applications such as intrusion detection, but also for the detection of acoustic processes in wellbores, the detection and tracking of tube waves, the monitoring of fluid flow, and many other applications. Such sensing applications may involve the direct detection of backscattered light (direct detection), or coherent detection, where the backscattered light generated in response to an interrogating optical pulse is mixed with a portion of the output of the optical source (i.e., the local oscillator), prior to optical-to-electrical conversion. In either case, the stability of the source frequency over timescales on the order of one second is important. In the case of coherent detection, the long delay between the emission of the interrogating optical pulse and that of the local oscillator puts even more stringent demands on the spectral purity of the optical source.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method of providing a narrow linewidth optical signal comprising:
providing an optical source to launch a frequency-stabilized optical signal at a first frequency into an optical fiber resonant cavity, wherein the first frequency corresponds to a longitudinal mode of the optical fiber resonant cavity;
pumping the optical fiber resonant cavity to stimulate a Brillouin emission;
controlling a Brillouin frequency shift of the optical fiber resonant cavity so that a gain of the Brillouin emission is substantially centered on a longitudinal mode of the optical fiber resonant cavity;
outputting a narrow linewidth optical signal at a first-order Stokes wavelength of the Brillouin emission; and
inducing a narrowband loss in the resonant cavity to suppress a second-order Stokes wavelength of the Brillouin emission.

2. The method as recited in claim 1, wherein a free spectral range of the optical fiber resonant cavity is at least the same value as the bandwidth of the gain of the Brillouin emission.

3. The method as recited in claim 1, wherein controlling the Brillouin frequency shift comprises straining at least a portion of the optical fiber forming the optical fiber resonant cavity.

4. The method as recited in claim 1, wherein controlling the Brillouin frequency shift comprises adjusting a temperature of the optical fiber resonant cavity.

5. A narrow linewidth optical source, comprising:
an optical fiber resonant cavity to produce a Brillouin emission in response to receipt of optical power;
an optical source to launch an optical signal at a first frequency into the optical fiber resonant cavity;
a frequency stabilization circuit to lock the first frequency to a longitudinal mode of the optical fiber resonant cavity; and
an output to provide a narrow linewidth optical signal at a first-order Stokes wavelength of the Brillouin emission; and
a narrowband loss device to suppress a second-order Stokes wavelength of the Brillouin emission within the optical fiber resonant cavity,
wherein a Brillouin frequency shift of the optical fiber resonant cavity is stabilized so that a gain of the Brillouin emission is substantially centered on a longitudinal mode of the optical fiber resonant cavity.

6. The narrow linewidth optical source as recited in claim 5, wherein the launched optical signal at the first frequency provides the optical power to stimulate the Brillouin emission.

7. The narrow linewidth optical source as recited in claim 5, further comprising a thermal element to adjust a temperature of the optical fiber resonant cavity to stabilize the Brillouin frequency shift.

8. The narrow linewidth optical source as recited in claim 5, further comprising a strain element to impart a strain on at least a portion of the optical fiber forming the optical fiber resonant cavity to stabilize the Brillouin frequency shift.

9. The narrow linewidth optical source as recited in claim 5, wherein the optical fiber resonator cavity comprises a polarization-maintaining optical fiber.
